(19) United States
(12) Patent Application Publication
(10) Pub. No.: US 2010/0206467 A1
(43) Pub. Date: Aug. 19, 2010

(54) METHOD OF COATING A PART WITH A LAYER OF LIGNEOUS MATERIAL, AND PART COATED WITH SUCH A LAYER

(75) Inventors: Nathalie Durand, Meru (FR); Hugo Piccin, Meru (FR)

Correspondence Address: YOUNG & THOMPSON, 209 Madison Street, Suite 500, Alexandria, VA, 22314, US

(73) Assignee: FAURECIA INTERIEUR INDUSTRIE, Nanterre (FR)

(21) Appl. No.: 12/682,936

(22) PCT Filed: Oct. 8, 2008
(86) PCT No.: PCT/FR08/51819

§ 371 Date: Apr. 14, 2010

(30) Foreign Application Priority Data
Oct. 15, 2007 (FR) 0707215

(51) Int. Cl. B32B 38/10; B32B 38/00; B29C 45/14

(52) U.S. Cl. 156/219; 156/278; 264/135

(57) ABSTRACT

A method for coating a component with a thin layer of ligneous material, includes selecting a sheet of coating constituted at least partially by a thin layer of ligneous material intended to be visible in the finished component, coating the surface of the sheet with a thin layer of a transparent composition containing a synthetic resin, and fixing the coated sheet to the surface of the component. In the fixing step, the layer of composition deposited on the surface of the sheet has a resilience which is at least 5% greater, and preferably at least 10% greater, than that of the thin layer of ligneous material in all directions, and the composition layer is transparent so that the layer of ligneous material is visible through the layer of composition. A step of engraving the surface of transparent composition opposite the layer of ligneous material is advantageous after coating.

The present invention relates to a method for producing a component having a surface which is coated with a layer of ligneous material, and a component coated with a layer of ligneous material.

For aesthetic reasons, it is often desirable to provide components with a layer of ligneous material, such as wood, for example, on portions of the dashboard or interior trim of a motor vehicle, these components sometimes having a non-developable shape.

Generally, these components are formed in a method in which at least some operations are manual, such as varnishing, finish sanding and the application of layers of varnish. These operations are necessary since, when the layer of ligneous material is curved, either a breakage of the fibres of ligneous material, with breakage or separation of the fibres, or folds occur frequently; these layers of ligneous material must then be coated with a powdered varnish on the ligneous material in large quantities since it must fill the cracks and gaps which exist in the ligneous material.

A method is also known in which a surface layer is produced using a plurality of layers of ligneous material which are compressed in one or more steps. This surface layer is then adhesively-bonded to a rigid support or used for overmoulding. The component obtained is then retouched by hand, in order to fill any cracks with a mastic or wood paste. Then, the component is varnished using a conventional varnish, for example, based on polyurethane, polyester or cellulose.

Such a production method has a number of disadvantages, since it requires the application of several layers of varnish, with manual varnish sanding between the layers. In this manner, the corner cracks provide an impression of poor quality. Some concave or convex shapes cannot be produced. Furthermore, the feel obtained provides a synthetic sensation, that is to say, very smooth, without the roughness of the ligneous material being able to be felt, unless the layer of varnish is very thin, a situation in which the protective function thereof, in particular against ultraviolet-radiation, is reduced.

In order to overcome these main disadvantages, that is to say, in order to prevent numerous production steps, at least some of which are manual, it has already been suggested to apply a flexible layer based on a synthetic resin to the outer surface of a layer of ligneous material, then to associate the complex obtained with the component in a compression operation, optionally with heating. To this end, the surface layer placed on the layer of ligneous material is flexible so that it adapts to the shape which the surface of the layer of ligneous material takes when it is placed between the surface of the component to be coated and the mould.

Although such a method avoids manual varnishing operations and hand polishing, it has been found that the implementation thereof was not effective when the surface is not planar, in particular since cracks form in the ligneous material at curved locations. At this time, the cracks can no longer be repaired owing to the presence of the flexible external layer. For this reason, it does not appear that such a method can be effectively used with layers of ligneous material.

Furthermore, the feel obtained is smooth, that is to say, different from that of the ligneous material, when the coating layer is sufficiently thick to provide protection.

The invention relates to the implementation of a method which has the advantage of the above-mentioned method, that is to say, allowing a decorative layer of ligneous material to be applied to a surface, even one which is non-developable, in a method in one step, but without having the disadvantages owing to the appearance defects which appear in the form of cracks. According to one improvement, the method allows the feel and the appearance of the ligneous material to be obtained, either directly or after engraving, when the coating layer is sufficiently thick to provide good protection.

More precisely, it has been found that, when there is used, for coating the outer surface of a support with a thin layer of ligneous material, a layer of a transparent composition whose resilience is at least 5% greater and preferably at least 10% greater than that of the thin layer of ligneous material, both in terms of traction and compression, this resilient external layer on the one hand applies to protruding portions tensile forces which are tangential relative to the surface of the thin layer of ligneous material, which thus retains its cohesion, and are distributed over this entire surface, and on the other hand applies to recessed portions compression forces which counteract the formation of folds, so that the visible side of the layer of ligneous material has neither cracks nor visible folds.

Such a method has a number of advantages. Firstly, it avoids the use of manual operations. The formation of the ligneous material/transparent composition complex is carried out when the layer of ligneous material is in the flat state or when it passes over a cylinder, and can therefore be readily coated in an industrial method. Another advantage results from the fact that the production of the finished component, from the non-coated component to obtaining the component covered with the ligneous material/composition complex, requires only a single operation in a press. Another advantage is that no retouching is required after the production. Another advantage is that the surface of the finished component may have a feel similar to that of the ligneous material.

More precisely, the invention relates to a method for coating a surface of a component with a thin layer of ligneous material, of the type comprising selecting a sheet of coating constituted at least partially by a thin layer of ligneous material which is intended to be visible in the finished component, coating the surface of the sheet with a thin layer of a composition which contains a synthetic resin, and fixing the coated sheet to the surface of the component; according to the invention, in the step of fixing the coated sheet, the layer of composition deposited on the surface of the sheet has a resilience at least 5% greater, and preferably at least 10% greater, than that of the thin layer of ligneous material in all directions, and the composition layer is transparent so that the layer of ligneous material is visible through the composition layer.

Preferably, the method comprises, after the step of coating the surface of the sheet with a thin layer of a composition containing a synthetic resin, a step of at least partially baking the composition. In one embodiment, the step of fixing the coated sheet to the surface of the component comprises a step of compressing the coated sheet against the surface of the component.

In another embodiment, the step of fixing the coated sheet to the surface of the component comprises a step of arranging the coated sheet in a mould with the layer of transparent composition against a surface of the mould and a step of injecting in the mould, at the side of the thin layer of ligneous material, a plastics material which is intended to constitute the body of the component.

Preferably, before the step of compressing the coated sheet against the surface of the component, an adhesive is arranged between the coated sheet and the surface of the component.

The step of selecting a coating sheet comprises selecting a sheet chosen from a sheet which is formed entirely by ligneous material, and a sheet which is formed by ligneous material arranged on a flexible support.

Preferably, after the step of coating the surface of the sheet and before fixing the coated sheet to the surface of the component, the method comprises a step of cutting a blank to a configuration which corresponds to that of the surface of the component to be coated.

The invention is particularly advantageous when the surface of the component is not planar, for example, when it is not developable. In this instance, the step of selecting a coating sheet advantageously comprises selecting a sheet which may be curved with a radius of 15 mm in all directions without cracking of the ligneous material.

Preferably, the coating step is selected from a coating step which is carried out in the flat state on a layer of ligneous material and a coating step which is carried out when the layer of ligneous material moves over a cylinder.

Preferably, the coating step is selected from a coating step which is carried out by means of roller application, a coating step which is carried out by means of projection and a curtain coating step.

Preferably, the transparent composition is selected from varnishes and lacquers.

In a variant, the transparent composition is coloured, for example, in order to modify the visible colour of the ligneous material.

According to a particularly advantageous improvement, the method comprises, after coating the surface of the sheet with a thin layer of a composition which contains a synthetic resin, a step of engraving the surface of transparent composition opposite the layer of ligneous material.

Preferably, the step of engraving the surface of the transparent composition is carried out using an engraving cylinder.

Preferably, the engraving step is carried out at a time at which the composition has already been subjected to at least part of the step of at least partially baking the composition, for example, a cross-linking operation.

It is advantageous for the step of fixing the coated sheet to the surface of the component to be carried out with heating at a temperature, for example, greater than 40° C., in particular between 90 and 130° C.

The invention also relates to a component having a surface which is coated with a layer of ligneous material, so that the outer surface of the layer of ligneous material is covered with a layer of a transparent composition which has a resilience which is at least 5% greater, and preferably at least 10% greater, than that of the thin layer of ligneous material in all directions.

For example, the coated surface of the layer of ligneous material is not planar and in particular is not developable.

Preferably, the outer surface of the layer of transparent composition is engraved. For example, the engraving pattern is representative of a texture of ligneous material.

Of course, the various steps of the method, which may each be known independently of the others, are implemented under conditions known to persons skilled in the art of production of components coated with ligneous material.

In the present publication, the term “transparent” is used to qualify the nature of the layer of composition, but this term also covers the expression “at least translucent” since the pattern of the ligneous material may also appear through such a translucent layer.

In the present publication, the term “resilience” refers to the resilience in terms of traction and compression since it is substantially the tensile forces which reduce the cracks and the compression forces which reduce the folds.

The various features of the invention will now be considered in greater detail.

The thin layer of ligneous material, which is considered to be wood below, may be entirely formed of wood or may be constituted by a thin layer of wood carried by a flexible support, such as a textile material, in particular a fabric or a non-woven fabric, a paper or a thin sheet of rubber.

The thickness of the thin layer of wood is naturally dependent on the smallest radius of curvature that the covering sheet must take up in the finished component, and the nature of the wood. For example, when a non-developable surface is coated, it is advantageous for the thin layer to be able to be curved to a radius of 15 mm in all directions without cracking of the wood before any processing according to the invention. The nature of the wood is dependent on the one hand on the variety of wood, which is more or less flexible or rigid depending on the origin, and the processing of the wood and, on the other hand, on the presentation of the layer, that is to say, the fact that it is continuous or is formed by adjacent pieces, and the direction of the cutting thereof, preferably along the grain of the wood.

The coating of the sheet can be carried out either in the flat state, for example, using a roller device, by means of projection or by passing through a curtain of the composition, or over a cylinder, for example, using a roller applied along a generating line of the cylinder, with the coating sheet being interposed. The coating on the cylinder may also be carried out by means of projection.

The synthetic resin can be based on natural or petrochemical ingredients.

It is advantageous for the step of coating the layer of wood to be an application operation, that is to say, the composition impregnates the wood so as to be well fixed so that it can effectively distribute the stresses. In a variant, it is advantageous, for some compositions, to apply to the surface of the wood, before coating with the transparent composition, a fixing layer, often referred to as a “primer” or “primary” layer. The two operations can also be cumulative.

When the transparent composition which is applied to the roller by means of projection or a curtain has inadequate resilience properties according to the invention, it must be subjected to a prior processing operation, for example, partial baking. For example, such a composition may be subjected to a baking polymerisation operation so that the coating layer has the resilience necessary for the method of the invention, that is to say, has a resilience at least 5% greater, and preferably at least 10% greater, than that of the thin layer of wood in all directions.

Although the transparent composition applied to the wood is preferably a type which has no chemical action on the appearance of the wood, the basic ingredients thereof may have a very variable chemical nature. According to the invention, the composition must be able to be placed in a physical state such that it has the necessary resilience when the complex is shaped, for example, in a mould.

In one example, it is possible to use, for example, as a transparent composition, a varnish which has a composition based on dual-component polyurethane. It is preferably applied to a fixing layer of conventional type. The thickness of the transparent composition layer after baking is advantageously between 20 and 100 μm. The wood/varnish complex is subjected to a baking operation of 30 minutes at 80° C. prior to its shaping, for example, by means of compression.

According to one possible improvement, the surface of the transparent composition opposite the layer of wood, either after or during baking, is subjected to a step of engraving the surface opposite the layer of wood so that the outermost surface in the finished component has, for example, a grain or a pattern which imitates the limits of the layers of cut wood. For example, the step of engraving the surface of the transparent composition is carried out using a roller having an engraving surface. In this manner, the layer of composition formed on the finished component may have a thickness which is sufficient to provide good protection whilst providing the feel and appearance of wood owing to the transparency of the composition.

The step of fixing the coated sheet to the surface of the component is carried out by compressing the coated sheet against the surface of the component. When the surface of the component is not planar, for example, non-developable, the operation is preferably carried out in a closed mould by means of a heating press.

More precisely, the compression comprises placing the complex, which is constituted by the coating sheet and the transparent composition, on the surface of the non-coated component, with an adhesive composition which is intended to fix the complex to the component being interposed. This adhesive composition may be of any known type so long as it provides adequate adhesive-bonding under the temperature and pressure conditions used in the compression step. The suppliers of such adhesive compositions set out these properties, so that the person skilled in the art can readily select an appropriate adhesive in accordance with the indications of the manufacturers and the characteristics of the component and the complex.

The shaping of the coating sheet to the form of the component, which has, for example, a non-developable surface, is carried out during the compression in which the thin layer of wood is shaped to the form of the surface and, simultaneously, the transparent layer applies to the surface of the wood, in the plane of the surface of the layer of wood, resilient forces which act counter to formation of cracks in the convex curved portions and to the formation of folds in the concave curved portions. This compression operation is advantageously carried out at a temperature greater than 40° C. and advantageously between 90° C. and 130° C.

When the coated component leaves the press, it is found on the one hand that the surface of the wood has neither folds nor visible cracks, and on the other hand that the outer surface of the composition has a pleasant feel, similar to that of wood, in particular when the complex has been subjected to the engraving operation. The component can be used in its existing state. When the component has not been subjected to the engraving operation, its properties in terms of feel are dependent on the surface state of the layer of transparent composition (smooth, satin, matt) and the surface state of the layer of wood.

In another method for implementing the fixing step, the compression of the coated sheet against the surface of the component is carried out by arranging the coated sheet in a mould so that the layer of transparent composition is adjacent to a surface of a half-mould, by closing a second half-mould on the first, and by injecting into the mould, at the side of the thin layer of wood, a plastics material which is intended to constitute the body of the component. Of course, such a method may be envisaged only when there is no risk of the injection temperature of the plastics material bringing about a deterioration of the properties of the wood/transparent composition complex.

After the fixing step, the transparent layer can be left in a flexible and resilient state; however, since it maintains the surface of the wood, preventing the formation of cracks and folds, it may also be subjected to an additional step, for example, more forced polymerisation when the baking has provided only a pre-polymerisation. In this operation, the surface of the layer of wood does not have the ability to create cracks since it is permanently retained in the shape obtained by application of forces distributed over the entire surface.

Although the invention has been described in its application in a component for the interior trim of a motor vehicle, the method can also be used in other fields, for example, in furniture, interior fixtures, boats or aircraft fixtures, for example.

Although the method for engraving the surface of the composition has been described as an improvement of the method for coating a surface which may or may not be planar, with a layer of transparent composition which has a resilience which is at least 5% greater, and preferably at least 10% greater, than that of the thin layer of ligneous material in all directions, this engraving method can also be used for non-transparent layers and/or layers which do not have a resilience at least 5% greater than that of the thin layer of ligneous material in all directions.

The above description indicates that all the operations can be carried out in an industrial manner, without any manual step. Consequently, the coated components obtained having a non-developable surface may be inexpensive, although the appearance obtained is excellent and often better than that provided by manual methods.

1. Method for coating a surface of a component with a thin layer of ligneous material, of the type comprising:
selecting a sheet of coating constituted at least partially by a thin layer of ligneous material which is intended to be visible in the finished component,
coating the surface of the sheet with a thin layer of a composition which contains a synthetic resin, and
fixing the coated sheet to the surface of the component,
characterised in that,
in the step of fixing the coated sheet, the layer of composition deposited on the surface of the sheet has a resilience at least 5% greater, and preferably at least 10% greater, than that of the thin layer of ligneous material in all directions, and the composition layer is transparent so that the layer of ligneous material is visible through the composition layer.

2. Method according to claim 1, characterised in that it comprises, after the step of coating the surface of the sheet with a thin layer of a composition containing a synthetic resin, a step of at least partially baking the composition.

3. Method according to claim 1, characterised in that the surface of the component is not planar.

4. Method according to claim 1, characterised in that the step of fixing the coated sheet to the surface of the component comprises a step of pressing the coated sheet against the surface of the component.

5. Method according to claim 1, characterised in that the step of fixing the coated sheet to the surface of the component comprises a step of arranging the coated sheet in a mould with the layer of transparent composition against a surface of the mould and a step of injecting in the mould, at the side of the thin layer of ligneous material, a plastics material which is intended to constitute the body of the component.

6. Method according to claim 1, characterised in that the step of selecting a coating sheet comprises selecting a sheet which may be curved with a radius of 15 mm in all directions without cracking of the ligneous material.

7. Method according to claim 1, characterised in that the coating step is selected from a coating step which is carried out in the flat state on a layer of ligneous material and a coating step which is carried out when the layer of ligneous material moves over a cylinder.

8. Method according to claim 1, characterised in that the coating step is selected from a coating step which is carried out by means of roller application, a coating step which is carried out by means of projection and a curtain coating step.

9. Method according to claim 1, characterised in that it comprises, after coating the surface of the sheet with a thin layer of a composition which contains a synthetic resin, a step of engraving the surface of transparent composition opposite the layer of ligneous material.

10. Component having a surface which is coated with a layer of ligneous material, characterised in that the outer surface of the layer of ligneous material is covered with a layer of a transparent composition which has a resilience which is at least 5% greater, and preferably at least 10% greater, than that of the thin layer of ligneous material in all directions.

11. Method according to claim 2, characterised in that the surface of the component is not planar.
